(19) United States
(12) Patent Application Publication
(10) Pub. No.: US 2025/0376270 A1
(43) Pub. Date: Dec. 11, 2025

(54) BAGGAGE CHUTE CUSHION

(71) Applicant: TMJ Products, Inc., Alhambra, CA (US)

(72) Inventors: Jones Tsui, Alhambra, CA (US); Lillian Tsui, Alhambra, CA (US)

(21) Appl. No.: 18/906,664

(22) Filed: Oct. 4, 2024

Related U.S. Application Data
(60) Provisional application No. 63/656,331, filed on Jun. 5, 2024.

(51) Int. Cl. B64F 1/32; B65G 11/20

(52) U.S. Cl. CPC B64F 1/324; B65G 11/203

(57) ABSTRACT

A baggage chute cushion to reduce damage to passenger baggage includes a layer of loose foam blocks; a resilient inner impact absorbing member including a contiguous layer of foam; and an outer casing covering the layer of loose foam blocks and the resilient inner impact absorbing member. The outer casing includes a rip-resistant fabric, and the contiguous layer of foam holds the layer of loose foam blocks within the outer casing.

### CROSS-REFERENCE TO RELATED APPLICATION(S)

The present application claims priority to and the benefit of U.S. Provisional

Application No. 63/656,331, filed Jun. 5, 2024, the entire content of which is incorporated herein by reference.

### BACKGROUND

### 1. Field

Aspects of embodiments of the present disclosure relate to a baggage chute cushion to reduce damage to passenger baggage.

### 2. Description of the Related Art

During aircraft boarding, when the overhead bin space becomes full, airlines routinely ask passengers to gate-check their carry-on items. These gate-checked items, along with items that cannot be stowed inside the overhead bins or under a seat, are temporarily held in the cabin area of the jet bridge before they are taken down to the cargo hold of the aircraft. These gate-checked items may be placed into an adjacent baggage chute to slide down to the ground level. The baggage handling personnel on the ground level will then retrieve these items to load into the aircraft's cargo compartment. A stopping mechanism, such as a rubber tire, may be provided at the bottom of the chute to catch the gate-checked items that are slid down the baggage chute. However, related art stopping mechanisms may provide inadequate protection for the gate-checked items and therefore the gate-checked items may become damaged.

The above-described information disclosed in this section is only for improving the understanding of the background of the present disclosure and thus it may include information that does not constitute prior art.

### SUMMARY

Aspects of embodiments of the present disclosure relate to a baggage chute cushion to reduce damage to passenger baggage. In one embodiment, the baggage chute cushion includes a layer of loose foam blocks; a resilient inner impact absorbing member including a contiguous layer of foam; and an outer casing covering the layer of loose foam blocks and the resilient inner impact absorbing member. The outer casing includes a rip-resistant fabric, and the contiguous layer of foam holds the layer of loose foam blocks within the outer casing.

The resilient inner impact absorbing member may be a foam block.

The outer casing may further include openings along a lower edge portion and grommets in the openings.

The baggage chute cushion may also include a lower cover member including the rip-resistant fabric.

The baggage chute cushion may include a rope laced through the openings and the grommets.

The baggage chute cushion may include strap segments on a sidewall of the outer casing, and each of the strap segments may form a channel.

The present disclosure also relates to various embodiments of a method of retrofitting a baggage chute. In one embodiment, the method includes positioning a baggage chute cushion on a stopping mechanism at a lower end of the baggage chute. The baggage chute cushion includes a resilient inner impact absorbing member and an outer casing covering the resilient inner impact absorbing member, and the outer casing includes a rip-resistant fabric and strap segments on a sidewall of the outer casing. The method also includes securing the strap segments of the baggage chute cushion to the baggage chute.

This summary is provided to introduce a selection of features and concepts of embodiments of the present disclosure that are further described below in the detailed description. This summary is not intended to identify key or essential features of the claimed subject matter, nor is it intended to be used in limiting the scope of the claimed subject matter. One or more of the described features or tasks may be combined with one or more other described features or tasks to provide a workable baggage chute cushion or a method of assembling a baggage chute cushion.

### BRIEF DESCRIPTION OF THE DRAWINGS

The features and advantages of embodiments of the present disclosure will be better understood by reference to the following detailed description when considered in conjunction with the drawings. The drawings are not necessarily drawn to scale.

FIG. 1 depicts a baggage chute cushion according to one embodiment of the present disclosure and illustrates where such a baggage chute cushion would be placed during use.

FIGS. 2A, 2B, 2C, and 2D depict steps for constructing a baggage chute cushion according to one embodiment of the present disclosure.

FIG. 3 is a photograph depicting three assembled baggage chute cushions according to one embodiment of the present disclosure.

### DESCRIPTION

The present disclosure relates to various embodiments of a baggage chute cushion configured to reduce damage to aircraft passenger baggage when the baggage is placed into a baggage chute adjacent to the aircraft and slid down to the ground level.

The terminology utilized herein is for the purpose of describing particular embodiments only and is not intended to be limiting of the present disclosure. As utilized herein, the singular forms “a”, “an” and “the” are intended to include the plural forms as well, unless the context clearly indicates otherwise. As utilized herein, the term “and/or” includes any and all combinations of one or more of the associated listed items.

It will be understood that, although the terms “first”, “second”, “third”, etc., may be utilized herein to describe one or more suitable elements, components, regions, and/or sections, these elements, components, regions, and/or sections should not be limited by these terms. These terms are only utilized to distinguish one element, component, region, layer or section from another element, component, region, layer or section. Thus, a first element, component, region, or section discussed could be termed a second element, component, region, or section, without departing from the spirit and scope of the present disclosure.

It will be understood that when an element is referred to as being “on”, “connected to”, “coupled to”, or “adjacent to” another element, it can be directly on, connected to, coupled to, or adjacent to the other element, or one or more intervening element(s) may be present. In contrast, when an element is referred to as being “directly on,” “directly connected to”, “directly coupled to”, or “immediately adjacent to” another element, there are no intervening elements present.

As utilized herein, the term “substantially” and similar terms are utilized as terms of approximation and not as terms of degree, and are intended to account for the inherent deviations in measured or calculated values that would be recognized by those of ordinary skill in the art. Also, the terms “about,” “approximately,” and similar terms, when utilized herein in connection with a numerical value or a numerical range, are inclusive of the stated value and refer to within an acceptable range of deviation for the particular value as determined by one of ordinary skill in the art, considering the measurement in question and the error associated with measurement of the particular quantity (e.g., the limitations of the measurement system).

Also, any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Example embodiments of the present disclosure will now be described with reference to the accompanying drawings. In the drawings, the same or similar reference numerals refer to the same or similar elements throughout. As utilized herein, the utilize of the term “may,” when describing embodiments of the present disclosure, refers to “one or more embodiments of the present disclosure.”

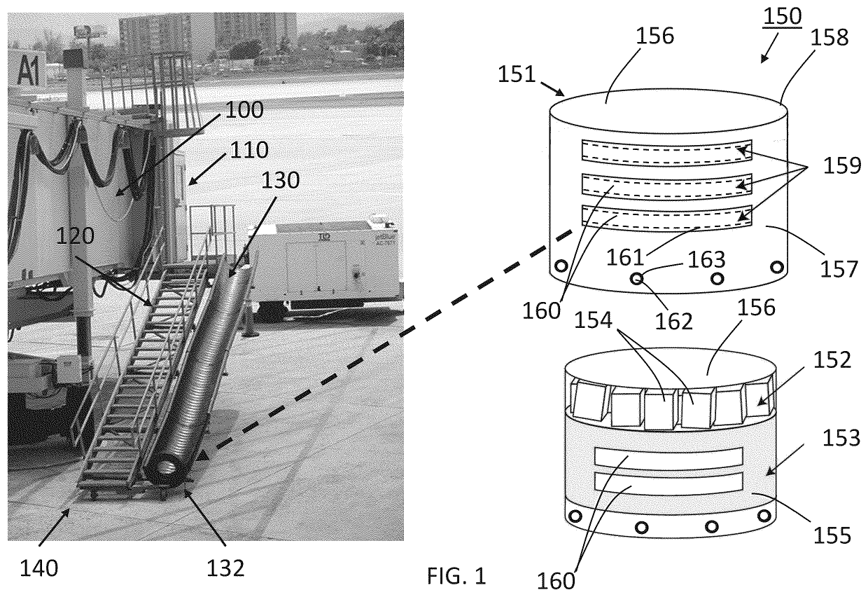

During aircraft boarding, when the overhead bin space becomes full, airlines routinely ask passengers to gate-check their carry-on items. These gate-checked items, along with items that cannot be stowed inside the overhead bins or under a seat, are temporarily held in the cabin area of the jet bridge before they are taken down to the cargo hold of the aircraft. FIG. 1 depicts an exterior view of a jet bridge 100. These gate-checked items may be carried through the jet bridge service door 110, and either hand-carried down the service stairs 120 or placed into the adjacent baggage chute 130 to slide down to the ground level 140. The baggage handling personnel on the ground level 140 will then retrieve these items to load into the aircraft's cargo compartment.

The jet bridge baggage chute 130 may have a semi-circular cross section that is directly next to the service stairs, leading diagonally from the cabin area of the jet bridge to the airport ramp ground. There is a “stopping mechanism” 132 at the bottom of the chute 130 to catch the items that are being slid down from atop.

Because of the steep slope of the baggage chute 130, the sliding items pick up great speed and momentum, especially because the end of the jet bridge 100 is often approximately 20 feet above the ground level 140. The high momentum of the heavy baggage leads to a high risk of damage to these items when they meet the stopping mechanism 132.

Aspects of embodiments of the present disclosure relate to a baggage chute cushion 150 placed on top of the chute stopping mechanism 132 to safely absorb the kinetic energy gained by the baggage as it slides down the chute. In the embodiment shown in FIG. 1, the baggage chute 130 has a semi-circular cross section and therefore the baggage chute cushion 150 is shown as having a cylindrical shape to fit within the chute 130. For example, the diameter of the baggage chute cushion 150 may be slightly smaller than the diameter of the semi-circular cross section of the chute 130.

While FIG. 1 shows a baggage chute 130 having a semi-circular cross section, other baggage chutes may have different cross-sectional shapes and cushions according to embodiments of the present disclosure may have corresponding shapes. For example, in the case of baggage chutes with rectangular or trapezoidal cross-sectional shapes, a baggage chute cushion 150 according to embodiments of the present disclosure may have matching shapes or other shapes that are suitable for the end of the baggage chute. Accordingly, in one or more embodiments, the cross-sectional shape of the baggage chute cushion 150 may correspond (or substantially correspond) to the cross-sectional shape of the chute 130. In one or more embodiments, the cross-sectional shape of the baggage chute cushion 150 does not correspond to the cross-sectional shape of the chute 130, such as where a cushion having a rectangular cross-sectional shape is used in a baggage chute with a trapezoidal cross-sectional shape.

The outer casing 151 of the baggage chute cushion 150 is made of a rip-resistant material such as a ripstop fabric. The outer casing 151 defines an interior space (e.g., a chamber or compartment) that is at least partially filled with at least two different layers of foam, an upper layer 152 and a lower layer 153. The upper layer 152 is at least partially filled with loose pieces of foam blocks 154, and the lower layer 153 is a singular foam disc 155. In the example shown in FIG. 1, the upper layer 152 is about (approximately) 3.5 inches thick, and the lower layer 153 is about (approximately) 10 inches thick, although the present disclosure is not limited thereto. Upon contact of an item sliding down the chute, the upper layer 152 of individual foam blocks 154 will compress and allow space between the blocks 154 to absorb and disperse the impact energy. The foam disc 155 of the lower layer 153, which is underneath the foam blocks 154 of the upper layer 152, serves as a structure to hold the loose foam blocks 154 in place, and to absorb the residual impact energy not absorbed by the upper layer 152.

The foam blocks 154 and the foam disc 155 each include an impact absorbing material. The impact absorbing material may be resilient (i.e., plastically deformable) such that the impact absorbing material is configured to compress during impact of the baggage and to return to its initial form (or substantially its initial form) after the baggage is removed. That is, upon contact of an item sliding down the chute, the cushion is compressed to absorb the impact force. When the items are removed from the chute, the cushion expands back to its original shape (or substantially back to its original shape) and to provide the same (or substantially the same) impact absorption functionality for the next baggage item.

The outer case 151 of the baggage chute cushion 150 includes a top surface 156 (e.g., an upper circular portion) and a sidewall 157 (e.g., a cylindrical sidewall) extended down from an outer periphery 158 (e.g., a circumferential edge) of the top surface 156. In some embodiments, the baggage chute cushion 150 includes built-in strapping mechanisms 159, which allows it to be secured to the body of the baggage chute 130. The built-in strapping mechanisms 159 may include a plurality of strap segments 160 stitched into the sidewall 157 of the rip-resistant fabric of the outer casing 151. The strap segments 160 may be provided in sets of two or more around the circumference of the sidewall (shown as an example in the figures as sets of three strap segments). Each of the strap segments 160 define a channel or tunnel 161 extending lengthwise along the strap segment 160 and circumferentially along a portion of the sidewall 157. The channels 161 are configured to receive an attachment mechanism securing the baggage chute cushion 150 to the chute 130. For instance, in one or more embodiments, straps, rope, or other attachment mechanisms may be looped through the channels 161 in the strap segments 160 on the sidewall 157 of the outer case 151 (which is formed of the rip-resistant material) and then secured to the structure of the chute 130. Additionally, in the illustrated embodiment, a lower edge portion of the sidewall 157 includes a plurality of openings 162 (e.g., holes) and a plurality of grommets 163 in the plurality of openings 162. In one or more embodiments, the baggage chute cushion 150 may also include a separate lower cover member (e.g., a flat circular piece of rip-resistant fabric) configured to cover an open lower end of the outer case 151. The lower cover member may be secured to the outer case 151 by lacing a rope or other tensile member through the grommets 163 and then tightening the tensile member.

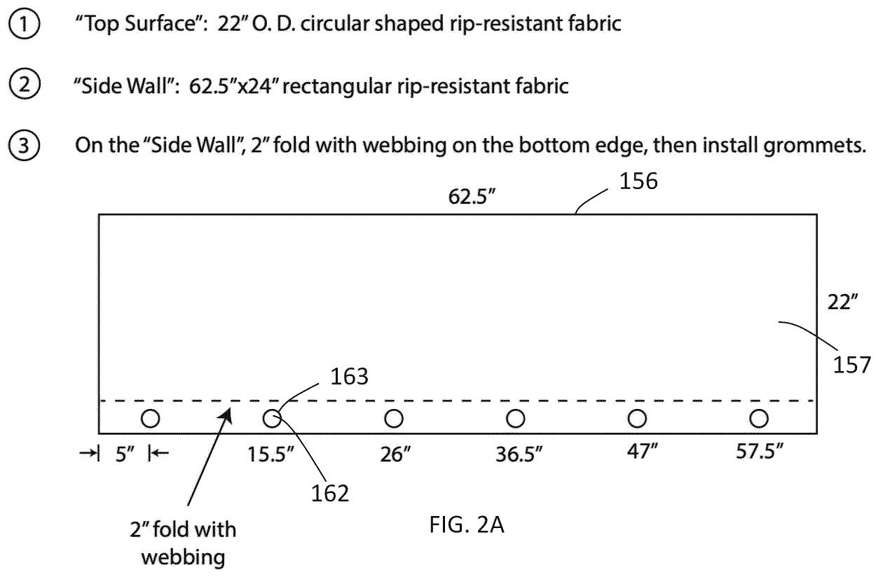

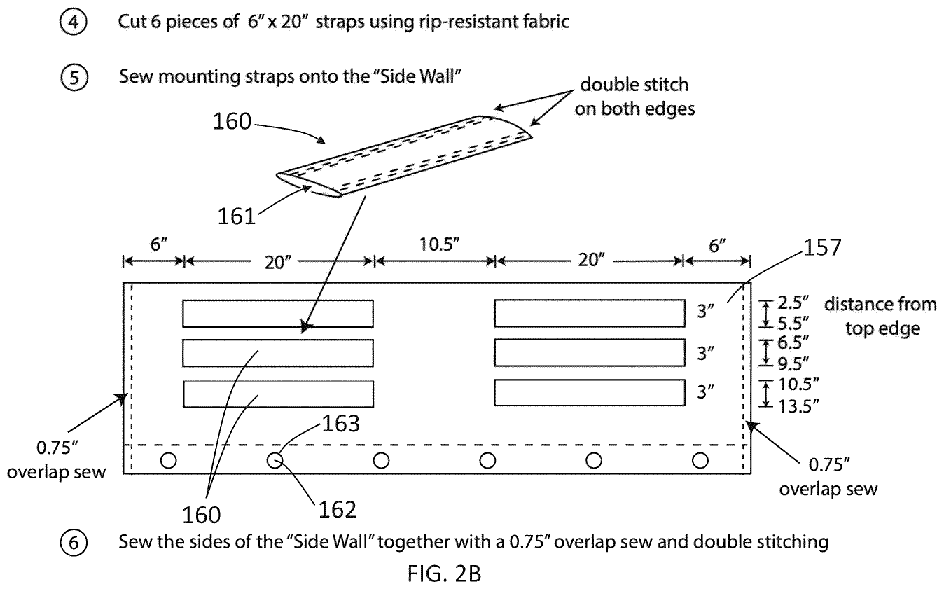

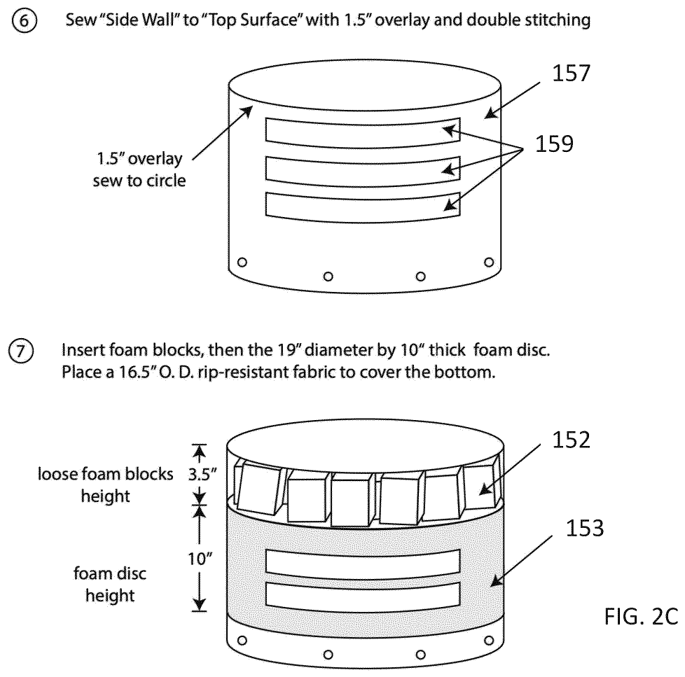

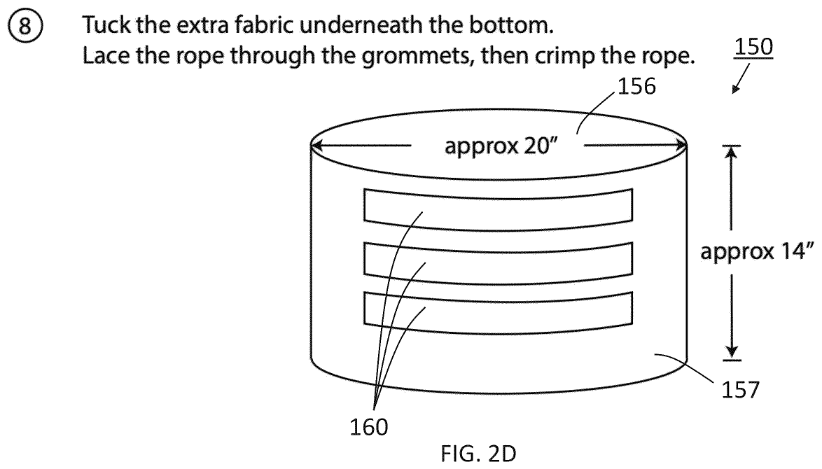

FIGS. 2A, 2B, 2C, and 2D depict steps for constructing a baggage chute cushion according to one embodiment of the present disclosure. While FIGS. 2A, 2B, 2C, and 2D depict a technique for assembling a cylindrical baggage chute cushion having a height of approximately 14 inches and a diameter of approximately 20 inches, embodiments of the present disclosure are not limited thereto and those skilled in the art would understand from the disclosure herein how to construct a baggage chute cushion according to other embodiments of the present disclosure to be suitable for baggage chutes of various shapes and sizes. In the illustrated embodiment, a lower edge portion of the sidewall includes a plurality of openings (e.g., holes) and a plurality of grommets in the plurality of openings. During assembly, the inner resilient impact absorbing members (e.g., the loose foam blocks and foam disc) are inserted into the outer casing, a separate lower cover member (e.g., a flat circular piece of rip-resistant fabric) is placed to cover a lower end of the inner resilient impact absorbing member, the lower edge portion of the sidewall including the grommets is folded or tucked underneath the bottom of the inner resilient impact absorbing member, and then a rope or other tensile member is laced through the grommets and tightened to secure the outer casing and the lower cover member to the inner resilient impact absorbing member.

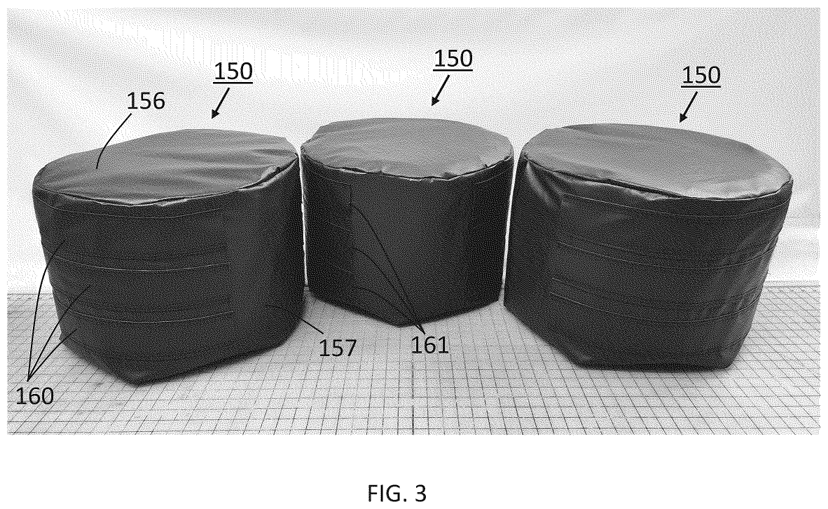

FIG. 3 is a photograph depicting three assembled baggage chute cushions according to one embodiment of the present disclosure.

Although some embodiments of the present disclosure have been disclosed herein, the present disclosure is not limited thereto, and the scope of the present disclosure is defined by the appended claims and equivalents thereof.

What is claimed is:

1. A baggage chute cushion comprising:
a layer of loose foam blocks;
a resilient inner impact absorbing member comprising a contiguous layer of foam; and
an outer casing covering the layer of loose foam blocks and the resilient inner impact absorbing member, the outer casing comprising a rip-resistant fabric,
wherein the contiguous layer of foam holds the layer of loose foam blocks within the outer casing.

2. The baggage chute cushion of claim 1, wherein the resilient inner impact absorbing member is a foam block.

3. The baggage chute cushion of claim 1, wherein the outer casing further comprises:
a plurality of openings along a lower edge portion; and
a plurality of grommets in the plurality of openings.

4. The baggage chute cushion of claim 3, further comprising a lower cover member comprising the rip-resistant fabric.

5. The baggage chute cushion of claim 4, further comprising a rope laced through the plurality of openings and the plurality of grommets.

6. The baggage chute cushion of claim 1, further a plurality of strap segments on a sidewall of the outer casing, each of the plurality of strap segments forming a channel.

7. A method of retrofitting a baggage chute, the method comprising:
positioning a baggage chute cushion on a stopping mechanism at a lower end of the baggage chute, the baggage chute cushion comprising:
a resilient inner impact absorbing member; and
an outer casing covering the resilient inner impact absorbing member, the outer casing comprising a rip-resistant fabric and a plurality of strap segments on a sidewall of the outer casing; and
securing the plurality of strap segments of the baggage chute cushion to the baggage chute.

8. A method of fabricating a baggage chute cushion, the method comprising:
inserting at least one resilient impact absorbing member into an outer casing; and
placing a cover on a lower end of the at least one resilient impact absorbing member.

9. The method of claim 8, wherein the inserting the at least one resilient impact absorbing member comprises inserting a contiguous layer of foam into the outer cover.

10. The method of claim 9, further comprising inserting a layer of loose foam blocks into the outer cover before the inserting of the contiguous layer of foam into the outer cover.

11. The method of clam 8, further comprising:
folding a lower edge portion of a sidewall of the outer casing underneath a lower end of the at least one resilient impact absorbing member; and
lacing a tensile member through grommets in the lower edge portion of the sidewall.
